(19) United States
(12) Patent Application Publication
(10) Pub. No.: US 2019/0306954 A1
(43) Pub. Date: Oct. 3, 2019

(54) A LIGHTING SYSTEM AND LIGHTING SYSTEM CONTROL METHOD

(71) Applicant: SIGNIFY HOLDING B.V., EINDHOVEN (NL)

(72) Inventors: OLAITAN PHILIP OLALEYE, WAKEFIELD, MA (US); TALMAI BRANDÃO DE OLIVEIRA, NORTH ANDOVER, MA (US); SIRISHA RANGAVAJHALA, WAKEFIELD, MA (US); ROHIT KUMAR, HACKENSACK, NJ (US); JASLEEN KAUR, MELROSE, MA (US); ABHISHEK MURTHY, ARLINGTON, MA (US); HASSAN MOHANNA, QUINCY, MA (US); ALEXANDRU DARIE, LINCOLN, MA (US)

(73) Assignee: SIGNIFY HOLDING B.V., EINDHOVEN (NL)

(21) Appl. No.: 16/339,156

(22) PCT Filed: Oct. 2, 2017
(86) PCT No.: PCT/EP2017/074932

§ 371 Date: Apr. 3, 2019

Related U.S. Application Data
(60) Provisional application No. 62/403,262, filed on Oct. 3, 2016.

(30) Foreign Application Priority Data
Oct. 18, 2016 (EP) 16194384.0

(51) Int. Cl. H05B 37/02; H04L 29/08

(52) U.S. Cl. CPC H05B 37/0227; H04L 67/18; H04L 67/12; H05B 37/0254

(57) ABSTRACT

A lighting-system (100) for illuminating an environment, the lighting system comprising a plurality of lighting modules (111, 112, 113) and a lighting-system control device (130). The lighting modules comprise: —a light source (121) for emitting light, —a programmable controller (122) configured to control an operation of the light source, and —a network interface (123) configured to allow the lighting module to communicate via a network. The lighting-system control device (130) comprises: —a processor circuit (133) configured to determine lighting control data to change the light spectrum of the light source based on the mobility data of the at least one user, and to transmit the lighting control data to at least one lighting module of the plurality of lighting modules to program said lighting module according to the lighting control data.

### FIELD OF THE INVENTION

The invention relates to a lighting-system, a lighting-system control device and a lighting-system control method.

### BACKGROUND

It has been known for some time that there is an effect of light on the circadian cycle. This can be exploited in a device that alters the circadian cycle of a user by changing the light to which the user is exposed.

A known example of such a device is given in U.S. Pat. No. 8,979,913, included herein by reference. A technology is disclosed that allows an individual to adjust his circadian rhythms to improve sleep. The user inputs a target wake time at which the user would like to awaken from sleep and the technology provides an exposure regimen via an exposure device for one or more days to alter the user's wake time.

Elsewhere, it has also been found that the spectrum of the light to which a user is exposed affects several aspects of the user including melatonin and cortisol levels and physiological effects. For example, different specific spectrums of light, in particular blue-enriched light, have been shown to improve performance levels but also affect sleep quality. Several studies have shown that white light can help in improving alertness. On the other hand, blue-enriched light increase melatonin levels which may cause sleeping problems if a user is exposed to such a light before he wants to go to bed. Similarly, color temperature and light intensity impact a user's health and/or sleep patterns.

Personalized lighting has the potential to improve learning enhancement or health improvement, etc. It is expected that increasingly, future installed lighting systems will be capable of intensity and multi-channel spectral modulation. Nevertheless, the inventors found technologies such as described in the above patent to have severe limitations. The known device computes the lighting regime solely on the user's programming of the device. After setting a desired wake time, the device will always at that particular time start some predetermined lighting regime. This makes the technology unsuitable for many applications.

For example, an outdoor light cannot be programmed using the above technology. Using the known device will result in an outdoor light that switches to a particular lighting regime suitable for a particular circadian rhythm at some preset time. Unfortunately, this circadian rhythm targeted by the light may or may not be appropriate for the people that happen to be exposed to that light.

### SUMMARY OF THE INVENTION

The inventors had the insight that mobility patterns of users often reveal their lighting needs for improving their performance and/or sleep. A lighting-system is provided for illuminating an environment is provided that uses mobility data to addresses the above problems.

The lighting-system comprises a plurality of lighting modules and a lighting-system control device. The lighting-system control device determines lighting control data to change the light spectrum of the light source. The plurality of lighting modules can be controlled by the lighting-system control device, and in particular a spectrum of the lighting modules can be changed by the lighting-system control device. The control data is based on the mobility data of at least one user. In an embodiment, the lighting control data is arranged to cause an increased or decreased blue-light content depending on the mobility data.

For example, while all commuters should be exposed to light at night to enable safe driving conditions, shift workers who commute to work at 3 AM could be exposed to higher levels of melatonin level suppressing blue-enriched light. At other locations, which are not used by shift-workers to go to work, but say, by people enjoying the night life, people may be better off not having bright blue-enriched light, but, e.g., rather with melatonin enhancing light, for which the part of the light in the blue color spectrum is reduced. Thus by using mobility data when determining, the distinction between going to work and going home can be established. Embodiments use these and other distinctions to control the lighting network. The invention avoids further disturbing the circadian rhythm of the people who are exposed to the light.

In an embodiment, mobility patterns and e.g., stay duration of the user(s) are a function of at least location. For example, in an embodiment, the processor circuit is configured to determine destination probabilities from stored mobility data. The destination probabilities are a function of at least location. For example, given a particular location, destination probabilities establish which location are likely targets of the present itinerary. The lighting control data for a particular location is determined based on the determined destination probabilities for that location. For example, if work related locations are the likely targets of a particular location, then work appropriate lighting may be used, e.g., bright white light. Other variables than location can be used when determining destination probabilities. For example, time of day and the direction in which a user is travelling have been shown to improve the accuracy of destination probabilities.

Commuters with similar migration patterns may be classified and a lighting recipe adapted to users along different routes and, e.g., different times.

In an embodiment, before a mobility-pattern is established, the processor circuit may profile the user(s) and cluster them into similar demographic subsets based on different information including, e.g., census, social media, survey data, amongst others.

Lighting modules and a lighting-system control device are electronic devices. A lighting-system control method described herein may be applied in a wide range of practical applications. Such practical applications include control of outdoor lighting, but also e.g., control of in-car lighting. A user who is travelling from work may be exposed to different light than a user who is travelling to work.

A method according to the invention may be implemented on a computer as a computer implemented method, or in dedicated hardware, or in a combination of both. Executable code for a method according to the invention may be stored on a computer program product. Examples of computer program products include memory devices, optical storage devices, integrated circuits, servers, online software, etc. Preferably, the computer program product comprises non-transitory program code stored on a computer readable medium for performing a method according to the invention when said program product is executed on a computer.

In a preferred embodiment, the computer program comprises computer program code adapted to perform all the steps of a method according to the invention when the computer program is run on a computer. Preferably, the computer program is embodied on a computer readable medium.

In a preferred embodiment, the estimation can be based on mobility patterns based on individual user data, for example, using global positioning logs, social media information, Wi-Fi sensing, location coordinates or using aggregated data across the users, for example, using call detail records (CDR), survey data, bulk GPS data, amongst others.

In another embodiment, it is possible that the estimation of the mobility pattern and stay duration can be estimated by the street lighting infrastructure or the city infrastructure. The sensing can be via reflectance, infra-red, luminance sensing, image analysis, and other methods.

In another embodiment, it is possible that the computation of the mobility patterns, transition probabilities and stay duration, can be executed on board each of (or in a distributed manner across) the smart computation enabled luminaires.

### BRIEF DESCRIPTION OF THE DRAWINGS

Further details, aspects, and embodiments of the invention will be described, by way of example only, with reference to the drawings. Elements in the figures are illustrated for simplicity and clarity and have not necessarily been drawn to scale. In the Figures, elements which correspond to elements already described may have the same reference numerals. In the drawings,

FIG. 1a schematically shows an example of an embodiment of a lighting system,

FIG. 1b schematically shows an example of an embodiment of a lighting-system control device,

FIG. 1c schematically shows an example of an embodiment of a light source,

FIG. 2 shows a schematic graph that indicates melatonin inhibition versus wavelength,

FIG. 3a schematically shows an example of an embodiment of a graph representation of a map of an environment,

FIG. 3b schematically shows an example of an embodiment of itineraries,

FIG. 4a schematically shows an example of mobility data clustering,

FIG. 4b schematically shows an example of mobility data parametrization,

FIG. 5 schematically shows an example of a street lighting system comprising one or more embodiments of a lighting-system,

FIG. 6a schematically shows flow diagram for a lighting-system control method,

FIG. 6b schematically shows flow diagram for a lighting-system control method,

FIG. 7a schematically shows a computer readable medium having a writable part comprising a computer program according to an embodiment,

FIG. 7b schematically shows a representation of a processor system according to an embodiment.

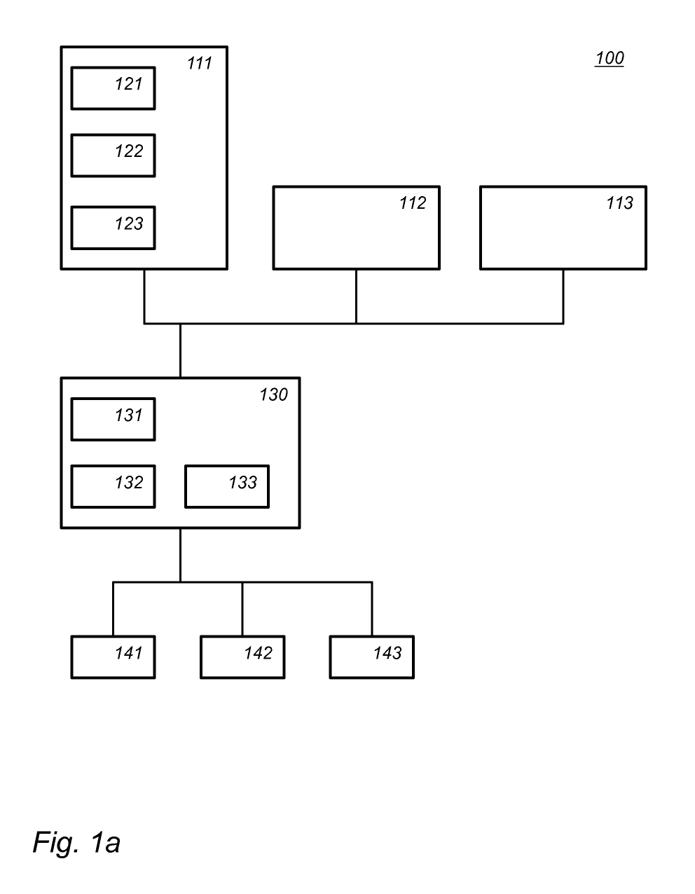

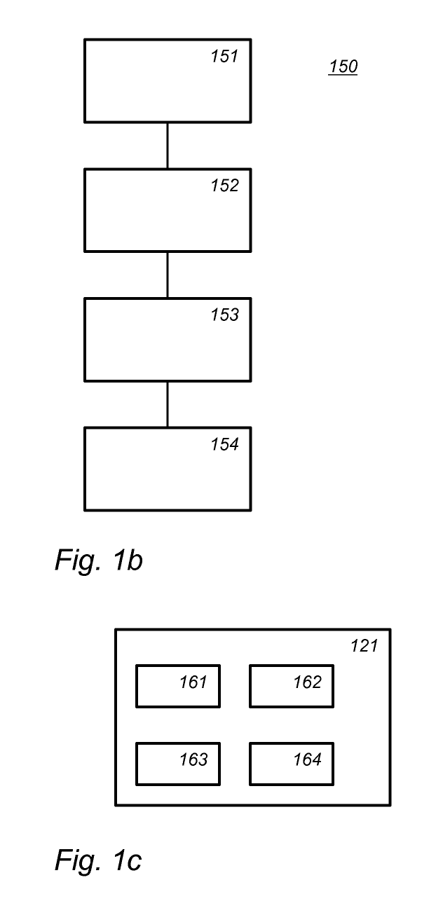

### LIST OF REFERENCE NUMERALS IN FIGS. 1A-3B

100 a lighting-system
111-113 a lighting module
121 a light source
122 a programmable controller
123 a network interface
130 a lighting-system control device
131 a receiver
132 a network interface
133 a processor circuit
141-143 a location tracking device
151 a storage
152 mobility data clustering unit
153 mobility data analysis unit
154 lighting control data unit
161 a white led
162 a red led
163 a blue led
164 a green led
210 wavelength axis in nm
220 Melatonin inhibition axis
300 a graph representation of an environment
310 a node
321-325 a location
331-333 an itinerary

### DETAILED DESCRIPTION OF PREFERRED EMBODIMENTS

While this invention is susceptible of embodiment in many different forms, there are shown in the drawings and will herein be described in detail one or more specific embodiments, with the understanding that the present disclosure is to be considered as exemplary of the principles of the invention and not intended to limit the invention to the specific embodiments shown and described.

In the following, for the sake of understanding, elements of embodiments are described in operation. However, it will be apparent that the respective elements are arranged to perform the functions being described as performed by them.

Further, the invention is not limited to the embodiments, and the invention lies in each and every novel feature or combination of features described herein or recited in mutually different dependent claims.

FIG. 1a schematically shows an example of an embodiment of a lighting system 100. The lighting system 100 is for illuminating an environment.

As explained in the background the lighting system 100 is arranged so that at least the spectrum of lighting is adapted to the needs of the users in the system, e.g., for improved sleep or performance. Different from the document cited in the background above mobility data is used to determine control data for lighting modules. In an embodiment, the lighting system 100 is further arranged so that the color temperature is adapted. The system may also adapt the intensity of the lighting to the needs of the users in the system. The environment may include but is not limited to an outdoor space or indoor space. For example, the lighting system 100 may illuminate a street, an office, a car interior, a home or likewise any space in which there may be human activity.

The lighting system 100 comprises a lighting-system control device 130 and a plurality of lighting modules. Shown are three lighting modules: lighting modules 111, 112, 113. In an embodiment, there may be two lighting modules, or more than three, e.g., more than 10, 100, or 1000, etc.

The lighting modules are configured to illuminate an environment, e.g., an indoor or outdoor space. The lighting modules 111, 112 and 113 may be of any type suitable for the specific implementation.

The lighting modules are configured to cooperate with lighting-system control device. FIG. 1 illustrates an embodiment of a light module for light module 111. Light module 111 comprises a light source 121 for emitting light, a programmable controller 122 configured to control an operation of the light source 121, and a network interface 123 configured to allow lighting module 111 to communicate via a digital network.

For example, in an embodiment, the lighting modules 111, 112 and 113 may comprise outdoor lighting modules. A lighting module for an outdoor application may in particular be a lighting poles, as further described in an embodiment below. Further examples of outdoor lighting modules include street lamps, e.g., luminaires, road signaling lamps, parking lot illumination modules, building illumination modules and the like.

In an embodiment, the lighting modules 111, 112 and 113 may comprise in-car lighting modules. Examples of in-car lighting modules include vehicle road lights, car instrumentation lights, and the like.

The light source 121 may be of any type for which the light spectrum can be changed through a programmable controller and is suitable for the specific implementation: for example, LEDs, fluorescent light bulbs, tungsten-halogen light, or the like. In an embodiment, the light source is a LED source arranged to have a controllable light spectrum. In an embodiment, the light source 121 is of a type in which the spectrum is changed by changing the color temperature.

Network interface 123 is arranged to receive lighting control data over the network, and to pass it onto programmable controller 122. Programmable controller 122 is configured to control the light spectrum of light source 121 through the control data. For example, the network may be a digital computer network, e.g., a LAN or WLAN network. For example, the network may be the internet, or a private network, etc.

Lighting-system control device 130 is arranged to change the spectrum of the light that illuminates the environment by sending corresponding control data to the lighting modules. Lighting-system control device 130 comprises a receiver 131, a network interface 132 and a processor circuit 133.

Receiver 131 is configured to receive mobility data of at least one user in the environment from one or more location tracking devices. Shown are tracking devices 141, 142, 143 which are arranged to collect said mobility data.

In an embodiment, a location tracking devices may be carried by a user to track his movement and to forward the thus collected mobility data to lighting-system control device 130. For example, a location tracking devices may be a mobile phone configured with software to operate as a tracking device. For example, software may be downloaded form a software repository, such as an app from, say, the Google play store. In an embodiment, the location tracking devices 141, 142, 143 comprise a GPS device, a GLONASS device, etc. In such embodiment, a tracking device is associated with a particular user, e.g., installed in his phone, or his car etc. For example, the location tracking devices 141, 142, 143 may be a mobile phone comprising a GPS or GLONASS receiver for tracking the position of the mobile phone.

Alternatively, a position of the mobile phone may be tracked via communication of the mobile phone with the base station device which wirelessly connects the mobile phone to the cellular network. Communication of the mobile phone with the base station device may occur via a digital cellular communication technology, as for example Global System for Mobile Communication (GSM), General packet radio service (GPRS), Enhanced Data Rates for GSM Evolution (EDGE), Universal Mobile Telecommunication System (UMTS), Digital Enhanced Cordless Telecommunications (DECT), LTE (long term evolution). A position of the mobile phone may be determined based on estimation of the distance of the mobile phone from neighboring mobile base station devices.

In embodiment, mobility data is collected using usage records of services related to the location of a user. Such usage records may be anonymized. For example, a spatiotemporal sensing mechanism can be based on bulk (possibly anonymized) spatiotemporal logs. Examples include so-called call detail records (CDR), social media data (e.g. tweets), Wi-Fi data, Bluetooth data, bulk GPS data, Google Maps or Waze transit data, Census Data, Survey Data amongst other. Such tracking mechanisms may collect mobility data whole sale.

Mobility data may also be obtained by collecting wireless computer network signals, such as Wi-Fi, Bluetooth signal, and the like. User(s) can also be classified into appropriate demographic subclasses based on census data, survey data and social media information towards better determination of appropriate subgroups with similar mobility patterns.

In an embodiment mobility data is anonymized, e.g., through an anonymizing unit (not separately shown). The anonymizing unit may be installed in lighting-system control device 130 or in a tracking device, or both. For example, an anonymizing unit may replace identifying data, e.g., a computer address, by random identifiers. For example, the relationship between the identifying data and the random identifiers may be stored in a content-addressable memory, e.g., an associative array.

In an embodiment, the mobility data comprises information from which the relationship between a current location of a person and a destination of traffic may be determined. In particular, the mobility data comprises multiple itineraries. It is convenient if the mobility data is organized as multiple itineraries, e.g., as multiple sequences of locations, having a start and finish location. However, this is not necessary, in an embodiment itineraries may be reconstructed from the mobility data, or the relationship between location and destination may be otherwise deduced from the mobility data.

In an embodiment, the mobility data obtained from, e.g., collecting digital signals comprising a digital identifier, e.g., Bluetooth data, GPS data etc., may be used to obtain sets of an identifier, a location, and preferably, a timestamp. From this data, itineraries may be reconstructed by selecting from the mobility data sets with the same identifier, and sorting on the timestamps. Appropriate heuristics may be used to identify start and finish locations, e.g., as locations in which the user of stationary for some time, e.g., longer than some threshold.

In an embodiment, the location tracking devices 141, 142, 143 may comprise survey data, e.g., in digital form, collecting information on the commuting habits of the user. In an embodiment the location tracking devices 141, 142, 143 may comprise outdoor cameras tracking movements of the user in the environment.

Network interface 132 is configured to allow the lighting-system control device 130 to communicate with the plurality of lighting modules 111, 112, 113 via the network. In particular, network interface 132 may be used by lighting-system control device 130 to send control data to a lighting module. In general, network interfaces 123 and 132 may take various forms, such as a network interface to a local or wide area network, e.g., the Internet, etc. The communication interface may be wired or wireless, etc.

Processor circuit 133 is configured to determine lighting control data to change the light spectrum of the light source 121 based on the mobility data of the at least one user, and to transmit the lighting control data to at least one lighting module 111 of the plurality of lighting modules 111, 112 and 113 to program said lighting module 111 according to the lighting control data. For example, lighting control data may be determined to change the light temperature. The lighting control data may also control light intensity.

In an embodiment, processor circuit 133 is configured to analyze the mobility data to establish a likely destination of users in that location. Based on the likely destination a decision is made on an appropriate lighting regime. In particular, the lighting control data may cause an increased or decreased blue-light content depending on the mobility data. Other aspects of the light that may be controlled include the intensity of the light.

In an embodiment, the at least one user is a single user. In this case the mobility data comprise the location of the user of a period of time, say over a period of a week or more. Using historic mobility data of a single user has the advantage that information obtained from the data has a high accuracy. For example, if the user is located at a particular location at a particular time, it is virtually certain that he is going to work. On the other hand, using only a single user has the disadvantage that using this data for controlling outdoor light may not be appropriate. In an embodiment, the at least one user are multiple users. For example, mobility data collected from multiple users may be clustered and/or statistically processed as is further explained below.

In an embodiment, lighting-system control device 130 comprises a storage configured to store the mobility data over a period of time. For example, lighting-system control device 130 may receive mobility data from multiple different users through tracking device 141-143 and stores the mobility data in the storage. For example, mobility data may be collected over a period of time, say at least a day, a week, a month, etc. After the collection or during the data may be analyzed to control the lighting modules.

Personalized lighting has been shown to exhibit significant potential to improve learning or health. Based on the mobility data, lighting control data is determined by the processor circuit 133 for changing the light spectrum of the light source 121 in order to, for example, improve general health condition of the user.

FIG. 1b schematically shows an example of an embodiment of a lighting-system control device 150. The lighting-system control device 150 comprises a storage 151, a mobility data clustering unit 152, a mobility data analysis unit 153, and a lighting control data unit 154. For example, units 152-154 may be implemented in processing circuit 133, for example as corresponding computer instructions.

Storage 151 is configured to store the mobility data of at least one user over a period of time.

Mobility data clustering unit 152 may be configured to cluster mobility data of multiple users.

Mobility data analysis unit 153 is configured to determine destination probabilities from the stored mobility data as a function of at least location.

A destination probability determined by the mobility data analysis unit 153 may be indicative of the probability that a user at a particular location is travelling to said destination.

Lighting control data unit 154 is configured to determine lighting control data to change the light spectrum of the light source based on the determined destination probabilities. For example, lighting control data may change the light temperature. Lighting control data can also control other aspects of the lighting, e.g., the light intensity.

In an embodiment, the lighting-system controller 130 assesses the health needs, including, e.g., circadian rhythm, melatonin, cortisol and physiological effects of specific cluster of commuting targets and delivers personalized tunable lighting to meet a predefined health goal, based on the commuting and/or duration of stay at a location patterns of the targets.

In an embodiment, a clustering algorithm aggregates commuters into clusters. The optional clustering algorithm may for example cluster sets of city inhabitants that have similar migration and duration at a location patterns as well as share similar transit routes.

A pattern quantification system may quantify the migration patterns of these clusters. The migration and locations of clusters of commuters can be quantified as a function of the time of the day, the specific cluster, the particular location and the time duration in addition to the other parameters.

Next is an analytics algorithm assess the health needs of the commuting clusters. The results from the analytics algorithm are transmitted to lighting modules based on an interconnected grid of color tunable, spectrally and/or intensity tunable light system. The analytics may generate real time insights and lighting recommendations based on the quantified mobility patterns of the target to the color, intensity and spectrally tunable lighting system. The interconnected set of tunable luminaires may deliver personalized health tuned lighting to the target person or cluster of commuters. This can include an outdoor system of street lights, in-car personalized lighting, in-home lighting or a collection of all or subsets of this light systems.

FIG. 1c schematically shows an example of an embodiment of a light source 121. Light source 121 may be a lighting emitting diode (LED) source. LED source 121 comprises four different color LEDs: a white led 161, a red led 162, a blue led 163 and a green LED 164. LED source 121 is a four-channel lighting element, i.e. having four-channels for driving the LED source 121. Lighting control data for LED source 121 has four channels, one for each LED.

Depending on the mobility data, one or more of the LEDs 161, 162, 163 or 164 may be selectively switched on or off to change the light spectrum of LED source 121. In an embodiment, color intensity of the LEDs 161, 162, 163 or 164 may be selectively increased or decreased to change the light spectrum of LED source 121.

In an embodiment, each LED 161, 162, 163 or 164 has a tunable spectrum within a wavelength range of the corresponding color. For example, red led 161 may have a tunable spectrum within the wavelength range of red color, e.g., within the range 630-680 nm.

Similarly, blue led 163 may have a tunable spectrum within the wavelength range of blue color, e.g., within the range 440-505 nm. The white LED 161 and the green LED 164 may have, similarly, a tunable spectrum within the wavelength range of the respective white and green color.

In an embodiment, the color of the light source 121 may be adapted such that the circadian rhythm of the user is better regulated, e.g., sleep hours per day are increased, or night hours and days hours are better differentiated throughout all seasons.

In an embodiment, the lighting control data may have a decreased blue-light content depending on the mobility data.

For example, in an embodiment the light source of a lighting module comprises multiple lights, e.g., multiple LEDs, the lighting-system controller 130 may store multiple profiles, each profile comprising a setting for each of the multiple lights of the lighting module. For example, a blue-enriched profile may drive a blue led of the lighting module more than a blue-decreased profile, and vice versa for a red and green led.

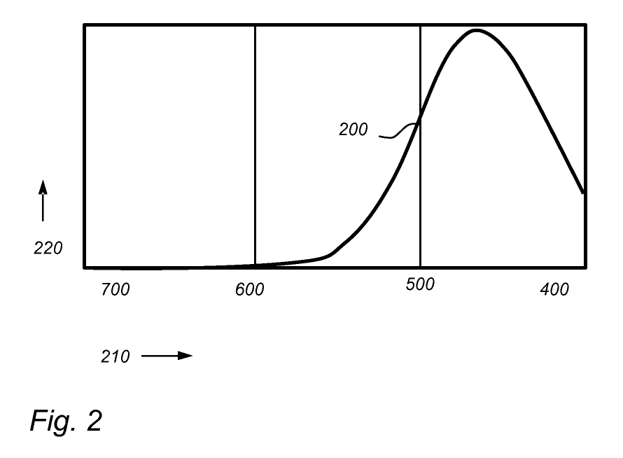

To explain further, FIG. 2 shows a schematic graph that indicates melatonin inhibition versus wavelength.

The curved line 200 represents the wavelengths of light that suppress secretion of the sleep-promoting hormone melatonin. Horizontal axis 210 indicates increasing light wavelength in nanometers (nm). Vertical axis 220 indicates increasing inhibition of melatonin.

It is known that changing spectrum of light in the environment of a person may improve performance levels and sleep quality of that person. In particular, it is known that melatonin, the hormone that enables sleep, contributes to regulating circadian rhythms of persons. When exposed to the blue component of the light before going to sleep, melatonin production is suppressed, sleep onset is delayed and sleep is more disturbed. Light exposure during the night is equally harmful, especially blue light produced by Light Emission Diode (LED), Televisions and computer screen, because, as shown in FIG. 2, such exposure suppresses the body's melatonin production which affects and disturbs the circadian rhythm. When the circadian rhythm is disturbed, the risk of illness is increased.

The lighting-system 100 may be configured such that the lighting control data have a decreased blue-light content when the mobility data indicate that the user will, for example, go to sleep within a predetermined period of time prior to sleep, e.g., within one hour or shorter or within one or two hours. By decreasing the blue-light content of the lighting control data, melatonin production is enhanced such that the sleep is promoted and the user can sleep more comfortably.

In an embodiment, the lighting control data has an increased blue-light content depending on the mobility data.

The lighting-system may be configured such that the lighting control data have a decreased blue-light content when the mobility data indicate that the user will, for example, wake up within a predetermined period of time prior to wake up. By increasing the blue-light content of the lighting control data, melatonin production is suppressed such that alertness is promoted and the user can better perform during the day hours.

Overall, by increasing and/or decreasing blue-light content in the lighting control data, the circadian rhythm of the user of the lighting-system 100 can be better regulated. Health of the user of the lighting-system is improved thanks to the promotion of more regular night sleep and day activity patterns.

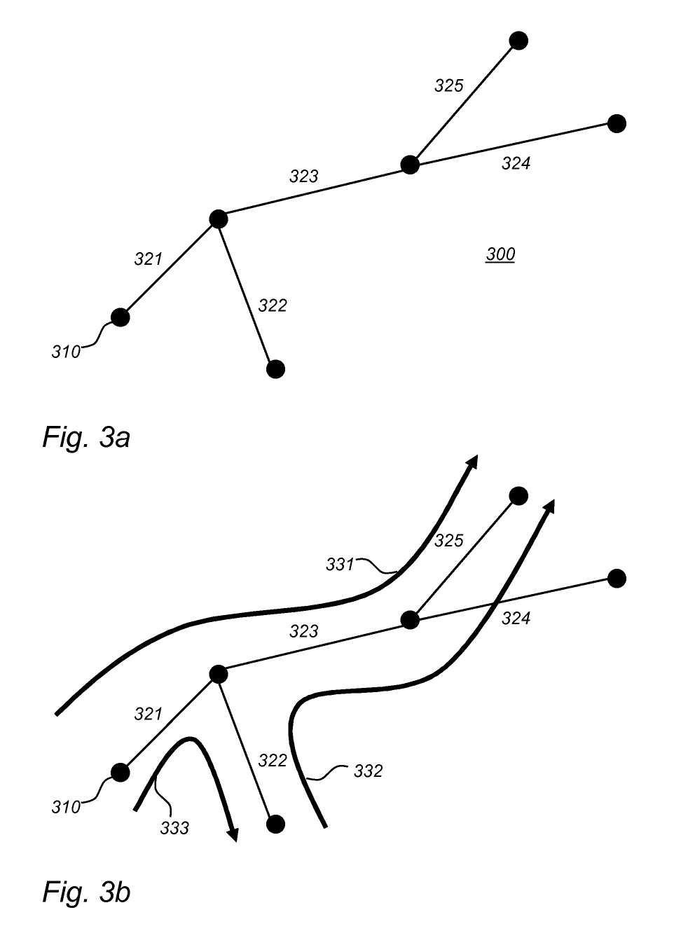

FIG. 3a schematically shows an example of an embodiment of a graph representation 300 of a map of an environment.

For example, the graph 300 may represent a road, terrain or topographic map.

In road maps, road segments may be identified by edges 321-325 in the graph 300. In terrain or topographic maps, route segment may be identified by edges 321-325. Edges 321-325 are locations along a map in the environment. Locations have node intersections defining specific start locations, intermediate locations or final locations, i.e. destinations. For example, in an embodiment graph 300 may be represented by storing for each node, the incoming and outgoing edges. In this case, lighting module locations may be represented as edges in the graph. Thus, for example, at node intersection between location 321 and location 322, all nodes of locations 321, 322 and 323 are stored in the storage.

FIG. 3b schematically shows an example of an embodiment of itineraries 331-333. The mobility data described in earlier embodiments may comprise multiple Itineraries 331-333. Itineraries may be defined as a sequence of locations 321-325 along the map. For example, itinerary 333 may be defined by the sequence of locations 321 and 322, itinerary 331 by the sequence of locations 321, 323 and 325 and itinerary 332 by the sequence of locations 322, 323 and 325. Nodes 310 and 322 may be considered as start locations and locations 322 and 325 as destinations. A user may thus arrive at destinations 322 and 325 from the start location 310.

In an embodiment, lighting-system controller 130 is configured to obtain migration patterns, e.g., destination transition probabilities from the mobility data. There are many ways how this may be done. For example, in an embodiment, lighting-system controller 130 is configured to obtain destination probabilities from the mobility data. Below one way to do this is described. In an embodiment, the storage of lighting-system controller 130 comprises multiple counters, a counter being associated with a location, e.g., one of the locations 321-325 and a destination, e.g., one of the destinations 322 or 325.

From the stored nodes, the processor circuit is configured to determine for a selected itinerary 331, 332 or 333, a destination 322 or 325. Destinations may be indicated in the mobility data, for example, if the mobility data is obtained from navigation software the destination may be explicitly available. Alternatively, a destination may be inferred using heuristics, e.g., a location where is stationary for a prolonged time, after travel may be classified as a destination.

The processor circuit may be configured to increase counters associated with a destination and a location along the itinerary 331, 332 or 333. The processor circuit is configured to determine the destination probabilities from said multiple counters. Consider table 1 below. Table 1 shows in the first column locations in graph 300 and in the first row destinations 322 and 325. For each itinerary towards a particular destination the counter associated with location on that itinerary and that destination are increased. For example, itinerary 333 towards destination 322 passes through locations 321 and 322. Thus, two entries in the first column, that are associated with destination 322 and locations 321 and 322 respectively are increased. In this case, itinerary 333 is the only itinerary towards 322 so the final counter after all itineraries are considered is 1 for these location-destination pairs.

TABLE 1

| | 322 | 325 |
|---|---|---|
| 321 | 1 | 1 |
| 322 | 1 | 1 |
| 323 | 0 | 2 |
| 324 | 0 | 0 |
| 325 | 0 | 2 |

For example, according to table 1 below, there is a 50% destination probability (corresponding to 1 in Table 1) that a user at location 321 travels to destination 322 and a 50% probability that he travels to destination 325. A user at location 322 has 50% probability to stay at destination 322 and 50% probability to travel to destination 325.

Note, a user at location 324 has zero destination probability to travel to destination 322 or destination 325 because there is no itinerary connecting location 324 to destination 322 or destination 325. If desired such anomalies may be avoided by starting each counter as a small positive initial value rather than 0, e.g., starting the counters in table 1 with 1 rather than 0.

This algorithm can process itineraries of multiple users as well as of a single user. For a single user, destination probabilities may be determined by tracking location of the user along itineraries of the user. As explained in the embodiment above, tracking the location of the user may include storing multiple counters and increasing such counters along the itinerary. The light spectrum of the light sources adapts to daily habits of the user, better regulating his circadian rhythm.

Based on said destination probabilities, lighting control data is determined to change the light spectrum of the light sources. The light sources may be located along the predetermined itinerary or be located next to the user and travelling with the user along the itinerary. The latter possibility includes for example in-car lighting. In an embodiment, a lighting module installed in a car. The lighting module may be configured to send real-time information regarding the location of the car to controlling device 130. Based on the location and optionally the time of day, etc., controlling device 130 determines appropriate light control data and send it to the lighting module in the car. For example, the data connection between car and controlling device may include a cellular network, e.g., LTE, etc.

In an embodiment, the destination probabilities are a function of multiple variables. These variables comprise but are not limited to time, location, distance from a current user location or predetermined destination. Such variables may for example comprise time of the day. Location tracking may include storing a time stamp associated with the location. Location tracking of the user may be associated to a time stamp. The determined lighting control data can change the light spectrum of the light sources based on destination probabilities which are changing with time. Light spectrum of light sources along multiple itineraries can be changed in function of the destination probability that a user has to reach a destination at different time of the day. For example, to extend the above algorithm with time of day, table 1 may be extended with an additional time axis. Alternatively, a separate graph may be created per time point. For example, in an embodiment FIG. 3b may be regarded as the graph for 3:00 am to 3:30 am. Time may be clustered, e.g., in whole or half hours, to increase the amount of available data per time point.

In an embodiment the destinations 322 and 325 may be assigned a classification. The classification may comprise at least one of the classes work and home. In the context of this document, “work” means any location where a physical and/or mental activity is being performed by a human being, and “work” includes wording like office, factory, workshop etc. In the context of this document, “home” means any location for sleeping or living, and includes wording like house, hotel, residence, etc. The processor circuit may be arranged to adapt the lighting control data to increase blue content in a location if a destination probability for the location is classified as work and passes a threshold probability. The processor circuit may be arranged to adapt the lighting control data to decrease blue content in a location if a destination probability for the location is classified as home and passes a threshold probability.

For example, referring to the example described with reference to FIG. 3b and Table 1, assuming that destination 325 is classified as work and that the user location is 323, if the threshold probability is 50% (1 in Table 1), then the destination probability that a user travels from location 323 to destination 325 is 100% (2 in Table 1). The processor circuit is in this case arranged to adapt the lighting control data to increase blue content in the light source at location 323, for example in the street lights at location 323.

This may help to improve alertness of the user at work.

In another example, assuming that destination 325 is classified as home and that the user location is 323 and that threshold probability is 50% (1 in Table 1), then the destination probability that a user travels from location 323 to destination 325 is 100% (2 in Table 1). The processor circuit is in this case is arranged to adapt the lighting control data to decrease blue content in the light source at location 323, for example in the street lights at location 323. This contributes to melatonin levels (see FIG. 2) and thus improves sleep quality of the user at home.

In an embodiment, the light profile chosen may depend only on the classification or on the classification and other factors, e.g., time of day. For example, if the classification is work this may always lead to a work light profile, e.g., having high white light; but if the classification is home, this may only lead to a sleep-friendly profile at certain hours, e.g., between 22:00 and 06:00.

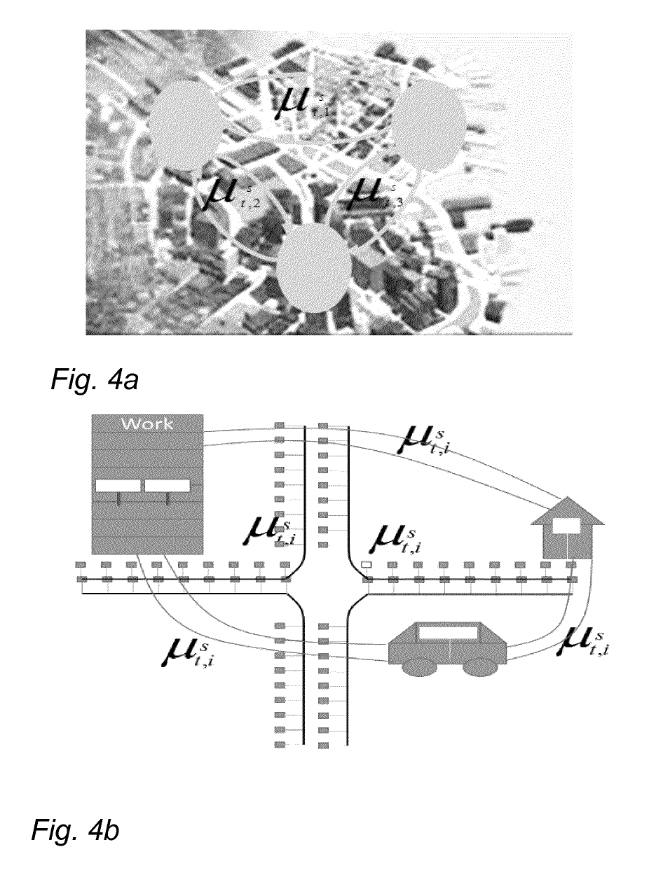

FIG. 4a schematically shows an example of mobility data clustering for multiple users. In an embodiment, the processor circuit is arranged to cluster mobility data of multiple users.

For example, the processor circuit may be arranged to quantify migration pattern across different parts of a city as shown by parameters μ connecting the spots in the map FIG. 4a. For mobility assessment of a cluster of users, the processor circuit may comprise the mobility data clustering unit 152 of FIG. 1b which aggregates users into clusters. The processor circuit may comprise a pattern quantification unit to quantify the migration patterns of these identical clusters. The processor circuit may comprise the mobility data analysis unit 153 of FIG. 1b to assess the health needs of the commuting clusters. The mobility data analysis unit 153 may provide the lighting control data that are transmitted to an interconnected network of spectrally and intensity tunable light sources associated with that cluster.

FIG. 4b schematically shows an example of mobility data parametrization. FIG. 4b indicates parametrization of the migration pattern of a user in different spaces with lighting interaction. μ_{t,i}^{s} may be a function of instantaneous time t, location s, direction i. Other parameters may include time duration and distance. Parametrization of mobility data for a user can be extended to a cluster of users as explained with reference to FIG. 4a.

In the event the lighting-system is configured for personalizing health of a single user, the processor circuit may comprise the pattern quantification unit and the mobility data analysis unit 153 for providing the lighting control data to be transmitted to the spectrally and intensity tunable light sources associated with the single user.

For example, consider the following scenario: At 3:00 AM about 90% of people on a factory road are going towards the factory to start a shift. At 3:30 AM about 90% of people on a factory road are going away from the factory, e.g., to a suburban area, since they just finished a shift. The algorithm explained in connection with FIGS. 3a and 3b, extended either with the variable time or direction will detect this difference. As a result, the lighting-system controller can control the lights along this road to have increased blue content around 3:00 AM and a reduced blue content around 3:30.

If the traffic on a location does not allow a sufficiently unambiguous light preference, then the controller may revert to a default light profile. In an embodiment, the controller is configured to control the lighting module with at least minimum light intensity needed for safe driving.

An embodiment may also be used for lighting in a restaurant. For example, in a first restaurant, the system may determine that most people are going to a concert later, in a second restaurant, people will go to work, and in a third restaurant people are going home to sleep. These scenarios can be automatically distinguished and differing lighting requirements appropriate for these scenarios may be sent in the form of control data. For example, light profiles may be retrieved as function of likely destination or likely destination classification.

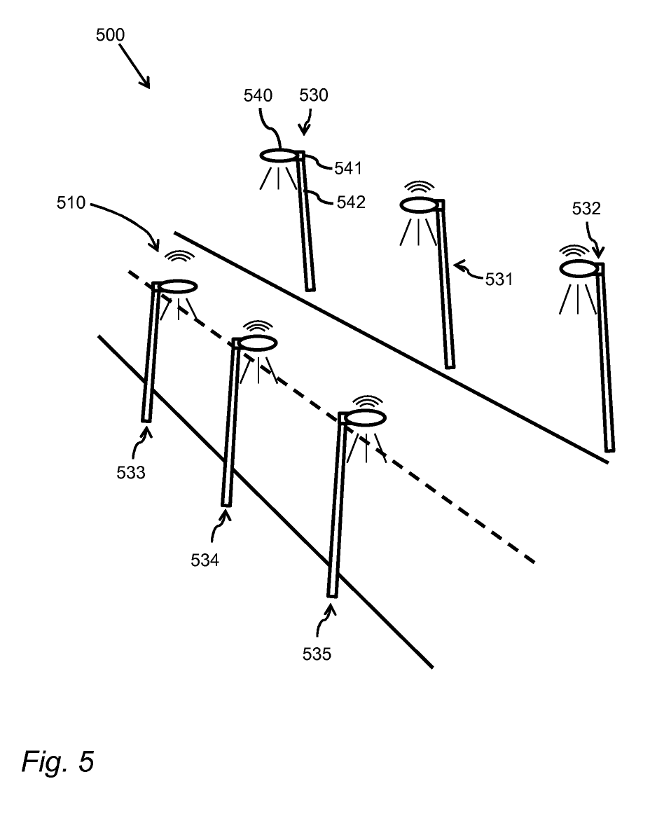

FIG. 5 schematically shows a street 510 with a street lighting system 500 comprising one or more embodiments of a lighting-system for illuminating an environment. Along the street, there are lighting poles 530-535 which form the street lighting system 500. In this document, the term lighting pole refers to the pole itself together with the light fixture at the top of the pole and additional optional driving circuitries provided in the pole and/or in the light fixture at the top of the pole. For lighting pole 530 distinct elements have been indicated, namely the light fixture 540, a lighting pole 542 and a construction element 541 at the top of the pole which comprises, for example, a driving circuitry for driving the light source in the light fixture 540.

In an example, the lighting modules of lighting-system 100 described with reference to FIG. 1 comprise lighting poles 530-535. For example, the light source 121 of the lighting module 111 is provided in the light fixture 540 and is focused on the street below the lighting pole 530.

In an embodiment, described with reference to FIG. 3a and FIG. 3b, a portion of the street close to lighting pole 530 may be part of the itinerary 331, 332 or 333 travelled by a user with associated destination probabilities.

Other elements of the lighting-system 100 of FIG. 1, such the network interface 123, the programmable controller 122 of the lighting module 111 may, for example, be provided in the element 341 that also may comprise the driving circuitry of the light source. The lighting pole 530, light fixture 540 or element 541 may comprise also the lighting-system control device 130 of FIG. 1, including the receiver 131 for receiving the mobility data, the network interface 132 to communicate with other lighting poles and the processor circuit 133 configured to determine lighting control data to change the light spectrum of a specific light source in the light fixture 540.

In an embodiment, street lighting infrastructure or the city infrastructure, e.g. a lighting pole, is configured to obtain mobility data, e.g., including stay duration, via reflectance, infra-red, luminance sensing, image analysis, and other methods.

With reference to the lighting-system 100 shown in FIG. 1, the network interfaces 123 of the lighting module 111 and network interface 132 of lighting-system control device 130 may be connected to a network via a wire or wireless connection for receiving and/or transmitting the lighting control data. The network interfaces 123 of the lighting module and network interface 132 of lighting-system control device 130 may comprise wired or wireless transmitters and/or wired or wireless receivers capable to receive and/or transmit the lighting control data via a suitable wired or wireless communication technology. The lighting pole 530, light fixture 540 or element 541 may comprise said wired or wireless transmitters and/or receivers. Examples of suitable wired or wireless communication technologies are but not limited to Ethernet, Bluetooth, Zig-Bee, Wi-Fi, Bluetooth Low Energy, mobile cellular technologies such as GSM, EDGE, LTE.

Light control data transmitted to one or more lighting poles 330-335 changes the light spectrum of the light source in the respective light fixture of the lighting pole.

For example, mobility data may indicate that a user id driving a vehicle along the street of the street lighting system 500. The user may be a night shift worker commuting with his vehicle from work to home at a specific time of the night. Based on said mobility data, the processor circuit in one of the lighting poles 530-535, may be configured to determine lighting control data to change the light spectrum of the light sources of the lighting poles 530-535 for decreasing the blue-light content of said light sources as said specific time of the night.

The lighting control data is transmitted from one lighting-pole to other lighting-poles such that the programmable controllers of said other lighting-poles can control operation of the respective light sources.

In an embodiment, not shown in the Figures, lighting poles 530-535 can communicate via the respective network interface to light source provided in lighting fixtures of the vehicle of the user such that the light spectrum of said vehicle light sources can also be changed based on the mobility data.

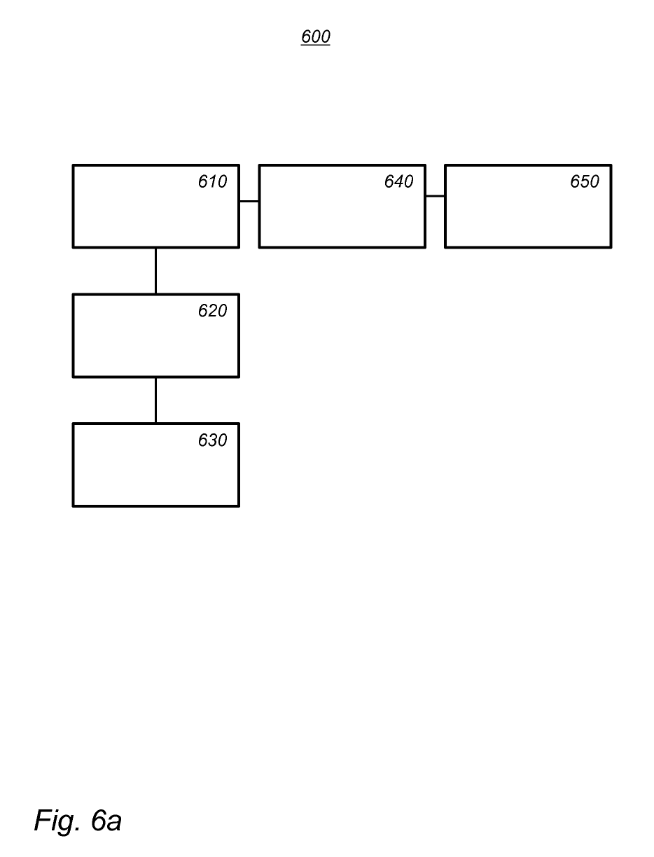

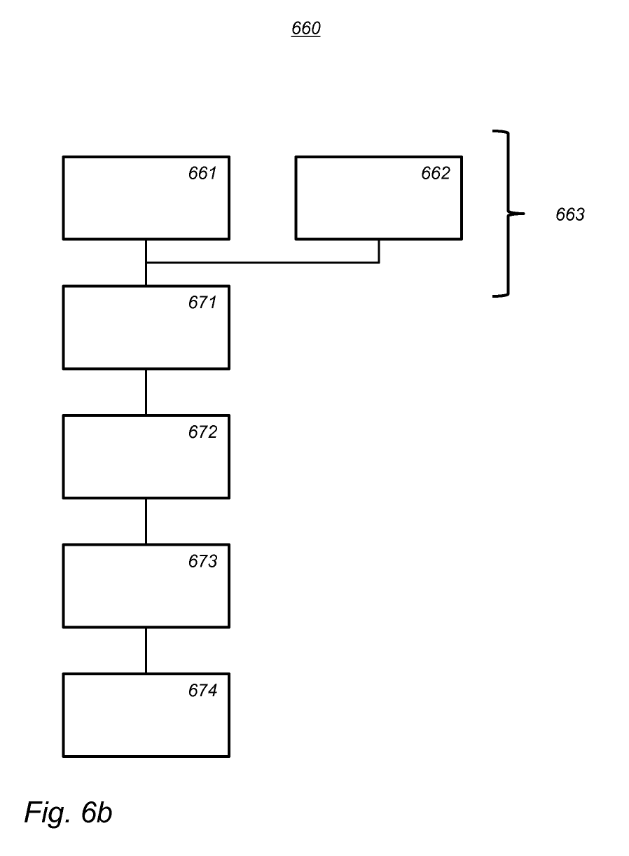

FIG. 6a schematically shows a flow diagram for a method 600 of controlling a lighting-system 600.

The method comprises receiving mobility data 610 of at least one user in an environment from one or more location tracking devices arranged to collect said mobility data, determining 620 lighting control data based on the mobility data of the at least one user, transmitting 630 the lighting control data to at least one lighting module of a plurality of lighting modules to program said lighting module according to the lighting control data using a network interface configured to allow the lighting-system control device to communicate with the plurality of lighting modules via the network. The lighting modules have been described with reference to FIG. 1 and comprise a light source for emitting light, a programmable controller configured to control an operation of the light source, and a network interface configured to allow the lighting modules to communicate via a network.

The method 600 may further comprise storing 640 the mobility data over a period of time, determining 650 destination probabilities from the stored mobility data as a function of at least location, wherein a destination probability for a particular destination is indicative of the probability that a user at a particular location is travelling to said destination. The lighting control data may be determined based on the determined destination probabilities.

FIG. 6b schematically shows a flow diagram for a method 660 of controlling a lighting-system 600.

FIG. 6b shows receiving 663 of mobility data of at least one user in the environment. Such mobility data may be obtained from a variety of sources. For example, shown in FIG. 6b is receiving 661 mobility data of at least one user in the environment from one or more location tracking devices (141, 142, 143) arranged to collect said mobility data. For example, FIG. 6b shows receiving 662 usage records of a location based service and obtaining the mobility data based thereon. FIG. 6b further shows in step 671 applying of a commuting clustering algorithm. For example, the commuting clustering may profile the user(s) and cluster them into similar demographic subsets based on different information including, e.g., census, social media, survey data, amongst others.

FIG. 6b further shows a step 672 in which a mobility pattern and/or duration pattern quantifier is applied. This step may be performed for individual users, for multiple users, or on clustered users. In step 673 a data analytics algorithm engine is applied to the mobility pattern and/or duration patterns that are obtained in by the mobility pattern and/or duration pattern quantifier. The data analytics algorithm engine may obtain lighting patterns, e.g., changing the spectrum, light temperature and/or light intensity. Finally, in step 674 the lighting modulus of a spectrally and/or intensity tunable connected luminaire system are programmed with the lighting patterns. Depending on the application some of the steps shown in FIG. 6b may be replaced or omitted. For example, if the invention is used to optimize light for a particular user, then no clustering of users is needed.

In the various embodiments, the network interface may be selected from various alternatives. For example, the network interface may be a network interface to a local or wide area network, e.g., the Internet, a storage interface to an internal or external data storage, a keyboard, etc.

Typically, the lighting modules 111-113, lighting-system control device 130 each comprise a microprocessor (not separately shown) which executes appropriate software stored at the device; for example, that software may have been downloaded and/or stored in a corresponding memory, e.g., a volatile memory such as RAM or a non-volatile memory such as Flash (not separately shown). The device 11-113, 130 may also be equipped with microprocessors and memories (not separately shown). Alternatively, the devices may, in whole or in part, be implemented in programmable logic, e.g., as field-programmable gate array (FPGA), or they may be implemented, in whole or in part, as a so-called application-specific integrated circuit (ASIC), i.e. an integrated circuit (IC) customized for their particular use. For example, the circuits may be implemented in CMOS, e.g., using a hardware description language such as Verilog, VHDL etc.

Many different ways of executing the method 600 are possible, as will be apparent to a person skilled in the art. For example, the order of the steps can be varied or some steps may be executed in parallel. Moreover, in between steps other method steps may be inserted. The inserted steps may represent refinements of the method such as described herein, or may be unrelated to the method. For example, steps 610, and 620 may be executed, at least partially, in parallel. Moreover, a given step may not have finished completely before a next step is started.

A method according to the invention may be executed using software, which comprises instructions for causing a processor system to perform method 600. Software may only include those steps taken by a particular sub-entity of the system. The software may be stored in a suitable storage medium, such as a hard disk, a floppy, a memory, an optical disc, etc. The software may be sent as a signal along a wire, or wireless, or using a data network, e.g., the Internet. The software may be made available for download and/or for remote usage on a server. A method according to the invention may be executed using a bitstream arranged to configure programmable logic, e.g., a field-programmable gate array (FPGA), to perform the method.

It will be appreciated that the invention also extends to computer programs, particularly computer programs on or in a carrier, adapted for putting the invention into practice. The program may be in the form of source code, object code, a code intermediate source, and object code such as partially compiled form, or in any other form suitable for use in the implementation of the method according to the invention. An embodiment relating to a computer program product comprises computer executable instructions corresponding to each of the processing steps of at least one of the methods set forth. These instructions may be subdivided into subroutines and/or be stored in one or more files that may be linked statically or dynamically. Another embodiment relating to a computer program product comprises computer executable instructions corresponding to each of the means of at least one of the systems and/or products set forth.

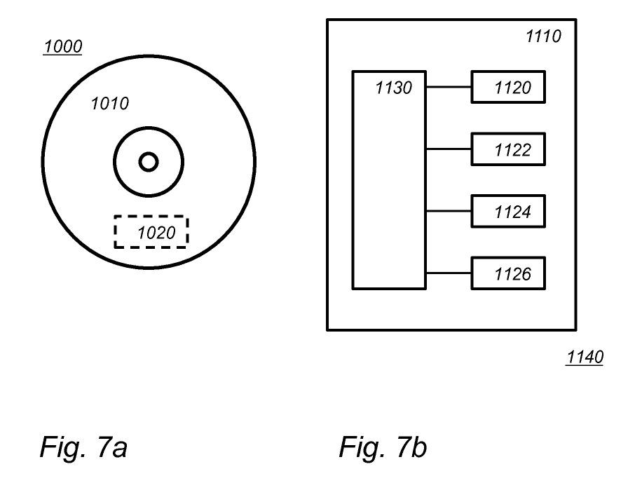

FIG. 7a shows a computer readable medium 1000 having a writable part 1010 comprising a computer program 1020, the computer program 1020 comprising instructions for causing a processor system to perform a lighting-system control method 600 according to an embodiment described with reference to FIG. 6a or FIG. 6b. The computer program 1020 may be embodied on the computer readable medium 1000 as physical marks or by means of magnetization of the computer readable medium 1000. However, any other suitable embodiment is conceivable as well. Furthermore, it will be appreciated that, although the computer readable medium 1000 is shown here as an optical disc, the computer readable medium 1000 may be any suitable computer readable medium, such as a hard disk, solid state memory, flash memory, etc., and may be non-recordable or recordable. The computer program 1020 comprises instructions for causing a processor system to perform said lighting-system control method 600.

FIG. 7b shows in a schematic representation of a processor system 1140 according to an embodiment. The processor system comprises one or more integrated circuits 1110. The architecture of the one or more integrated circuits 1110 is schematically shown in FIG. 7b. Circuit 1110 comprises a processing unit 1120, e.g., a CPU, for running computer program components to execute a method according to an embodiment and/or implement its modules or units. Circuit 1110 comprises a memory 1122 for storing programming code, data, etc. Part of memory 1122 may be read-only. Circuit 1110 may comprise a communication element 1126, e.g., an antenna, connectors or both, and the like. Circuit 1110 may comprise a dedicated integrated circuit 1124 for performing part or all of the processing defined in the method. Processor 1120, memory 1122, dedicated IC 1124 and communication element 1126 may be connected to each other via an interconnect 1130, say a bus. The processor system 1110 may be arranged for contact and/or contact-less communication, using an antenna and/or connectors, respectively.

For example, in an embodiment, the lighting-system control device 130 may comprise a processor circuit and a memory circuit, the processor being arranged to execute software stored in the memory circuit. For example, the processor circuit may be an Intel Core i7 processor, ARM Cortex-R8, etc. The memory circuit may be an ROM circuit, or a non-volatile memory, e.g., a flash memory. The memory circuit may be a volatile memory, e.g., an SRAM memory. In the latter case, the verification device may comprise a non-volatile software interface, e.g., a hard drive, a network interface, etc., arranged for providing the software.

It should be noted that the above-mentioned embodiments illustrate rather than limit the invention, and that those skilled in the art will be able to design many alternative embodiments.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

In the claims references in parentheses refer to reference signs in drawings of embodiments or to formulas of embodiments, thus increasing the intelligibility of the claim. These references shall not be construed as limiting the claim.

1. A lighting-system for illuminating an environment, the lighting system comprising:
a plurality of lighting modules, the lighting modules comprising:
a light source for emitting light,
a programmable controller configured to control an operation of the light source, and
a network interface configured to allow the lighting module to communicate via a network, and
a lighting-system control device comprising:
a receiver configured to receive mobility data of at least one user in the environment,
a network interface configured to allow the lighting-system control device to communicate with the plurality of lighting modules via the network, and
a processor circuit configured to determine lighting control data to change the light spectrum of the light source based on the mobility data of the at least one user, and to transmit the lighting control data to at least one lighting module of the plurality of lighting modules to program said lighting module according to the lighting control data,
wherein the lighting-system control device comprise a storage configured to store the mobility data over a period of time, the processor circuit being configured to determine destination probabilities from the stored mobility data as a function of at least location, wherein a destination probability for a particular destination is indicative of the probability that a user at a particular location is travelling to said destination, the lighting control data being determined based on the determined destination probabilities,
and wherein the destinations are assigned a classification, the classification comprising at least one of the classes work and home, wherein processor circuit being arranged to:
adapt the lighting control data to increase blue content in a location if a destination probability for the location is classified as work and passes a threshold probability, and/or
adapt the lighting control data to decrease blue content in a location if a destination probability for the location is classified as home and passes a threshold probability.

2. A lighting-system as in claim 1, wherein the lighting control data is arranged to cause an increased or decreased blue-light content depending on the mobility data.

3. A lighting-system as in claim 2, wherein the destination probabilities are a function of multiple variables further comprising time of day.

4. A lighting-system as in claim 3, wherein the storage comprises multiple counters, a counter being associated with a location in the environment and a destination, the mobility data comprises multiple itineraries, the processor circuit is configured to determine for an itinerary a destination, and to increase counters associated with the destination and a location along the itinerary, the destination probabilities being determined from said counters.

5. A lighting-system as in claim 1, wherein the processor circuit is arranged to cluster mobility data of multiple users.

6. A lighting-system as in claim 1, wherein the lighting modules comprise out-door lighting modules.

7. A lighting-system as in claim 1, wherein the lighting modules comprise in-car lighting modules.

8. A lighting-system as in claim 1, wherein:
the receiver is configured to receive mobility data of at least one user in the environment from one or more location tracking devices arranged to collect said mobility data, or, wherein
the mobility data is based on usage records of a location based service.

9. A lighting-system as in claim 1, wherein the lighting control data is arranged to tune one or more of the color temperature, intensity and spectrum of the light depending on the mobility and demographic information.

10. A lighting-system control device comprising:
a receiver configured to receive mobility data of at least one user in an environment from one or more location tracking devices arranged to collect said mobility data,
a network interface configured to allow the lighting-system control device to communicate with a plurality of lighting modules via the network, the lighting modules comprising a light source for emitting light, a programmable controller configured to control an operation of the light source, and a network interface configured to allow the lighting modules to communicate via a network, and
a processor circuit configured to determine lighting control data based on the mobility data of the at least one user, and to transmit the lighting control data to at least one lighting module of the plurality of lighting modules to program said lighting module according to the lighting control data,
a storage configured to store the mobility data over a period of time, the processor circuit being configured to determine destination probabilities from the stored mobility data as a function of at least location, wherein a destination probability for a particular destination is indicative of the probability that a user at a particular location is travelling to said destination, the lighting control data being determined based on the determined destination probabilities,
and wherein the destinations are assigned a classification, the classification comprising at least one of the classes work and home, wherein processor circuit being arranged to:
adapt the lighting control data to increase blue content in a location if a destination probability for the location is classified as work and passes a threshold probability, and/or
adapt the lighting control data to decrease blue content in a location if a destination probability for the location is classified as home and passes a threshold probability.

11. A lighting-system control method, comprising:
receiving, mobility data of at least one user in an environment from one or more location tracking devices arranged to collect said mobility data,
determining lighting control data based on the mobility data of the at least one user,
transmitting the lighting control data to at least one lighting module of a plurality of lighting modules to program said lighting module according to the lighting control data using a network interface configured to allow the lighting-system control device to communicate with the plurality of lighting modules via the network, the lighting modules comprising a light source for emitting light, a programmable controller configured to control an operation of the light source, and a network interface configured to allow the lighting modules to communicate via a network,
storing the mobility data over a period of time,
determining user commuting cluster profiles, mobility patterns, destination probabilities from the stored mobility data as a function of at least location, wherein a destination probability for a particular destination is indicative of the probability that a user at a particular location is travelling to said destination, the lighting control data being determined based on the determined destination probabilities,
assigning a classification to the destinations, the classification comprising at least one of the classes work and home,
adapting the lighting control data to increase blue content in a location if a destination probability for the location is classified as work and passes a threshold probability, and/or
adapting the lighting control data to decrease blue content in a location if a destination probability for the location is classified as home and passes a threshold probability.

12. A lighting-system control method as in claim 11, wherein the destination probabilities are a function of multiple variables further comprising time of day.

13. A computer readable medium comprising transitory or non-transitory data representing instructions to cause a processor system to perform the method according to claim 11.
